(19) United States
(12) Patent Application Publication
(10) Pub. No.: US 2023/0376845 A1
(43) Pub. Date: Nov. 23, 2023

(54) INFORMATION PROCESSING APPARATUS, INFORMATION PROCESSING METHOD, AND STORAGE MEDIUM

(71) Applicant: NEC Corporation, Tokyo (JP)

(72) Inventors: Keisuke Suzuki, Tokyo (JP); Masanori Tsujikawa, Tokyo (JP)

(73) Assignee: NEC Corporation, Tokyo (JP)

(21) Appl. No.: 18/198,037

(22) Filed: May 16, 2023

(30) Foreign Application Priority Data
May 23, 2022 (JP) 2022-083887

(51) Int. Cl. G06N 20/00

(52) U.S. Cl. CPC G06N 20/00

(57) ABSTRACT

In order to more appropriately determine a range of a hyperparameter for use in learning by a gradient descent method, an information processing apparatus (1) includes: an acquisition unit (11) that acquires at least one selected from the group consisting of a condition to be satisfied by a loss function, a target error, a condition concerning an initial value of the gradient descent method, and a dimension of a model parameter; and a determination unit (12) that determines a range to be satisfied by at least one hyperparameter selected from the group consisting of a plurality of hyperparameters for use in learning by the gradient descent method, the range being determined in accordance with information which has been acquired by the acquisition unit (11).

This Nonprovisional application claims priority under 35 U.S.C. § 119 on Patent Application No. 2022-083887 filed in Japan on May 23, 2022, the entire contents of which are hereby incorporated by reference.

### TECHNICAL FIELD

The present invention relates to a technique for learning by a gradient descent method.

### BACKGROUND ART

Learning by a gradient descent method requires setting of hyperparameters (an inverse temperature, a learning rate, the number of parameter update times, a sample size, etc.). Examples of a method that is conventionally used to set a hyperparameter include a grid search and a random search. That is, various patterns are tried, so that a pattern which has the best result is selected. Patent Literature 1 discloses adjusting a learning rate in a stochastic gradient descent method in accordance with information pertaining to a gradient of a loss function. Non-patent Literature 1 discloses non-convex learning by stochastic gradient Langevin dynamics (SGLD), which is a common variation of the stochastic gradient descent method.

### CITATION LIST

### Patent Literature

[Patent Literature 1]

International Publication No. WO 2017/183587

### Non-Patent Literature

[Non-Patent Literature 1]

M. Raginsky, A. Rakhlin, and M. Telgarsky, Non-Convex Learning via Stochastic Gradient Langevin Dynamics: A Nonasymptotic Analysis, In Proceedings of the 2017 Conference on Learning Theory, volume 65, pp. 1674-1703, 2017.

### SUMMARY OF INVENTION

### Technical Problem

However, use of a method such as a grid search or a random search unfortunately requires much time for trials of various patterns. In the technique disclosed in Patent Literature 1, the learning rate can be adjusted in consideration of the gradient of the loss function. However, the technique disclosed in Patent Literature 1 has room for improvement in order to more appropriately determine a hyperparameter for use in learning by the gradient descent method.

An example aspect of the present invention has been made in view of the above problems, and an example object thereof is to provide a technique that makes it possible to more appropriately determine a range of a hyperparameter for use in learning by a gradient descent method.

### Solution to Problem

An information processing apparatus in accordance with an example aspect of the present invention includes at least one processor, the at least one processor carrying out: an acquisition process for acquiring at least one selected from the group consisting of a condition to be satisfied by a loss function, a target error, a condition concerning an initial value of a gradient descent method, and a dimension of a model parameter; and a determination process for determining a range to be satisfied by at least one hyperparameter selected from the group consisting of a plurality of hyperparameters for use in learning by the gradient descent method, the range being determined in accordance with information which has been acquired in the acquisition process.

An information processing method in accordance with an example aspect of the present invention is configured to include: (a) acquiring at least one selected from the group consisting of a condition to be satisfied by a loss function, a target error, a condition concerning an initial value of a gradient descent method, and a dimension of a model parameter; and (b) determining a range to be satisfied by at least one hyperparameter selected from the group consisting of a plurality of hyperparameters for use in learning by the gradient descent method, the range being determined in accordance with information which has been acquired in the above (a), the above (a) and (b) being carried out by at least one processor.

A non-transitory storage medium in accordance with an example aspect of the present invention stores an information processing program for causing a computer to carry out: an acquisition process for acquiring at least one selected from the group consisting of a condition to be satisfied by a loss function, a target error, a condition concerning an initial value of a gradient descent method, and a dimension of a model parameter; and a determination process for determining a range to be satisfied by at least one hyperparameter selected from the group consisting of a plurality of hyperparameters for use in learning by the gradient descent method, the range being determined in accordance with information which has been acquired in the acquisition process.

### Advantageous Effects of Invention

An example aspect of the present invention makes it possible to more appropriately determine a range of a hyperparameter for use in learning by a gradient descent method.

### BRIEF DESCRIPTION OF DRAWINGS

FIG. 1 is a block diagram illustrating a configuration of an information processing apparatus in accordance with a first example embodiment.

FIG. 2 is a flowchart showing a flow of an information processing method in accordance with the first example embodiment.

FIG. 3 is a block diagram illustrating a configuration of an information processing apparatus in accordance with a second example embodiment.

FIG. 4 is a diagram illustrating a procedure 1 in accordance with the second example embodiment.

FIG. 5 is a diagram illustrating a procedure 2 in accordance with the second example embodiment.

FIG. 6 is a diagram illustrating a procedure 3 in accordance with the second example embodiment.

FIG. 7 is a flowchart showing a flow of an information processing method in accordance with the second example embodiment.

FIG. 8 is a diagram illustrating display data displayed on a display panel.

FIG. 9 is a diagram illustrating the display data displayed on the display panel.

FIG. 10 is a view illustrating an example of a computer that executes instructions of a program which is software realizing functions of apparatuses in accordance with example embodiments of the present invention.

### DESCRIPTION OF EMBODIMENTS

### First Example Embodiment

A first example embodiment of the present invention will be described in detail with reference to the drawings. The first example embodiment is an embodiment serving as a basis for example embodiments described later.

(Configuration of Information Processing Apparatus)

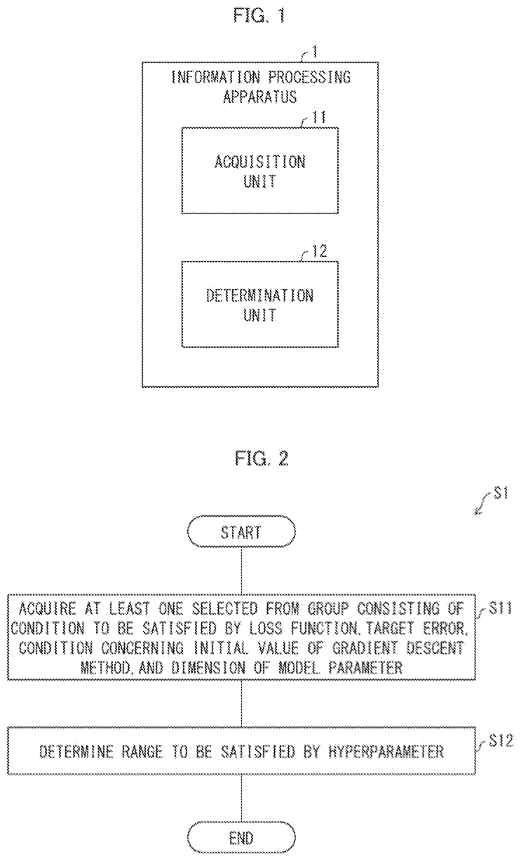

A configuration of an information processing apparatus 1 in accordance with the first example embodiment will be described with reference to FIG. 1. FIG. 1 is a block diagram illustrating the configuration of the information processing apparatus 1. The information processing apparatus 1 includes an acquisition unit 11 and a determination unit 12.

The acquisition unit 11 acquires at least one selected from the group consisting of a condition to be satisfied by a loss function, a target error, a condition concerning an initial value of a gradient descent method, and a dimension of a model parameter. The condition to be satisfied by the loss function includes, for example, at least one selected from the group consisting of the following:
(i) a constant representing an upper bound of a norm at an origin of a gradient of the loss function;
(ii) a constant representing a Lipschitz constant of the gradient of the loss function; and
(iii) a constant representing dissipativity of the loss function.

The condition concerning the initial value of the gradient descent method includes, for example, at least one selected from the group consisting of the following:
(iv) a constant representing an upper bound of a secondary moment of an initial distribution; and
(v) a constant representing an upper bound of a quaternary moment of the initial distribution.

The determination unit 12 determines a range to be satisfied by at least one hyperparameter selected from the group consisting of a plurality of hyperparameters for use in learning by the gradient descent method, the range being determined in accordance with information which has been acquired by the acquisition unit 11. The plurality of hyperparameters include, for example, at least one selected from the group consisting of a sample size of training data, a learning rate, and the number of parameter update times. The plurality of hyperparameters may include an inverse temperature.

Note, however, that in the above hyperparameters, the inverse temperature needs to be fixed in order to determine a hyperparameter other than the inverse temperature. Note also that the learning rate needs to be fixed in order to determine the number of parameter update times. That is, in a case where the determination unit 12 does not determine the inverse temperature and the learning rate, and some fixed values are used as the inverse temperature and the learning rate, these fixed values also need to be input to the information processing apparatus 1. Thus, the inverse temperature and the learning rate that are not determined by the determination unit 12 are included in an input.

As described above, the information processing apparatus 1 in accordance with the first example embodiment employs a configuration including: the acquisition unit 11 that acquires at least one selected from the group consisting of a condition to be satisfied by a loss function, a target error, a condition concerning an initial value of a gradient descent method, and a dimension of a model parameter; and the determination unit 12 that determines a range to be satisfied by at least one hyperparameter selected from the group consisting of a plurality of hyperparameters for use in learning by the gradient descent method, the range being determined in accordance with information which has been acquired by the acquisition unit 11. Thus, the information processing apparatus 1 in accordance with the first example embodiment brings about an effect of making it possible to more appropriately determine a range of a hyperparameter for use in learning by a gradient descent method.

(Information Processing Program)

The functions of the information processing apparatus 1 described earlier can also be realized by a program. An information processing program in accordance with the first example embodiment causes a computer to function as the acquisition unit 11 and the determination unit 12. This information processing program brings about an effect of making it possible to more appropriately determine a range of a hyperparameter for use in learning by a gradient descent method.

(Flow of Information Processing Method)

A flow of an information processing method S1 in accordance with the first example embodiment will be described with reference to FIG. 2. FIG. 2 is a flowchart showing the flow of the information processing method S1. Note that steps of the information processing method may be carried out by a processor of the information processing apparatus 1 or by a processor of another apparatus.

Alternatively, the steps may be carried out by processors provided in respective different apparatuses.

In S11, at least one processor acquires at least one selected from the group consisting of a condition to be satisfied by a loss function, a target error, a condition concerning an initial value of a gradient descent method, and a dimension of a model parameter. In S12, the at least one processor determines a range to be satisfied by at least one hyperparameter selected from the group consisting of a plurality of hyperparameters for use in learning by the gradient descent method, the range being determined in accordance with information which has been acquired in the step S11.

As described above, the information processing method S1 in accordance with the first example embodiment is configured such that: at least one processor carries out (i) a process for acquiring at least one selected from the group consisting of a condition to be satisfied by a loss function, a target error, a condition concerning an initial value of a gradient descent method, and a dimension of a model parameter; and the at least one processor carries out (ii) a process for determining a range to be satisfied by at least one hyperparameter selected from the group consisting of a plurality of hyperparameters for use in learning by the gradient descent method, the range being determined in accordance with information which has been acquired in the process (i). Thus, the information processing method S1 in accordance with the first example embodiment brings about an effect of making it possible to more appropriately determine a range of a hyperparameter for use in learning by a gradient descent method.

### Second Example Embodiment

A second example embodiment of the present invention will be described in detail with reference to the drawings. Note that members having functions identical to those of the respective members described in the first example embodiment are given respective identical reference numerals, and a description of those members is omitted as appropriate.

<Configuration of Information Processing Apparatus 1A>

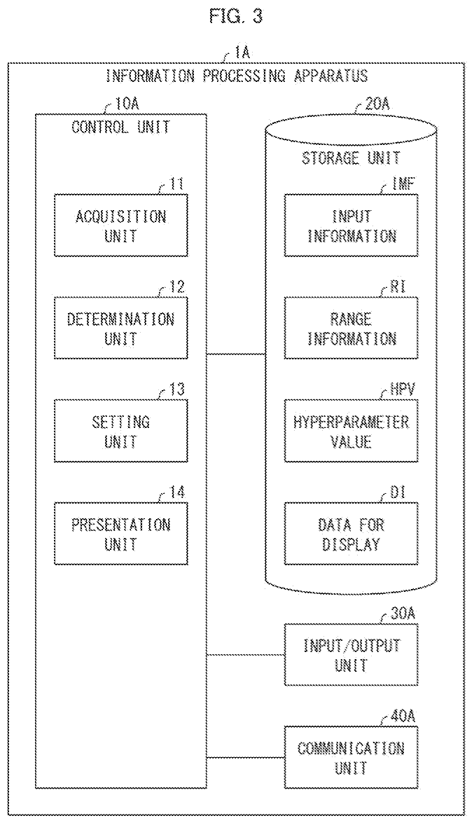

FIG. 3 is a block diagram illustrating a configuration of an information processing apparatus 1A. The information processing apparatus 1A includes a control unit 10A, a storage unit 20A, an input/output unit 30A, and a communication unit 40A.

(Input/Output Unit 30A)

The input/output unit 30A includes, for example, a display panel, a loudspeaker, a keyboard, a mouse, and/or a touch panel. The input/output unit 30A receives an input of various pieces of information to the information processing apparatus 1A. The input/output unit 30A outputs various pieces of information under control by the control unit 10A. An input/output apparatus(s) such as a display panel, a loudspeaker, a keyboard, a mouse, and/or a touch panel may be connected to the input/output unit 30A. Examples of the input/output unit 30A include an interface such as a universal serial bus (USB).

(Communication Unit 40A)

The communication unit 40A communicates, via a communication line, with an apparatus external to the information processing apparatus 1A. A specific configuration of the communication line does not limit the first example embodiment. Examples of the communication line include a wireless local area network (LAN), a wired LAN, a wide area network (WAN), a public network, a mobile data communication network, and a combination thereof. The communication unit 40A transmits, to another apparatus, data supplied from the control unit 10A, and supplies, to the control unit 10A, data received from another apparatus.

(Control unit 10A)

The control unit 10A includes the acquisition unit 11, the determination unit 12, a setting unit 13, and a presentation unit 14.

(Acquisition Unit)

The acquisition unit 11 acquires at least one selected from the group consisting of the following:
(a) a condition to be satisfied by a loss function;
(b) a target error;
(c) a condition concerning an initial value of a gradient descent method; and
(d) a dimension of a model parameter.
   Note here that (a) the condition to be satisfied by the loss function and (c) the condition concerning the initial value of the gradient descent method are as described in the foregoing first example embodiment. The model parameter is a parameter of a model that is learned by the gradient descent method.

(Determination Unit)

The determination unit 12 determines a range to be satisfied by at least one hyperparameter selected from the group consisting of a plurality of hyperparameters for use in learning by the gradient descent method, the range being determined in accordance with information which has been acquired by the acquisition unit 11. The at least one hyperparameter is as described in the foregoing first example embodiment.

(Setting Unit and Presentation Unit)

The setting unit 13 sets a value of the at least one hyperparameter so that the value falls within the range which has been determined by the determination unit 12. The presentation unit 14 presents the range which has been determined by the determination unit 12.

(Storage Unit)

The storage unit 20A stores various data that are used by the information processing apparatus 1A. The storage unit 20A stores, for example, input information IMF, range information RI, at least one hyperparameter value HPV, and data DI for display.

(Input Information)

The input information IMF collectively refers to (a) the condition to be satisfied by the loss function, (b) the target error, (c) the condition concerning the initial value of the gradient descent method, and (d) the dimension of the model parameter. The above (a) to (d) have been acquired by the acquisition unit 11. The input information IMF may also include an inverse temperature.

(Range Information, at least one Hyperparameter Value, and Data for Display)

The range information RI is information indicative of the range that has been determined by the determination unit 12. The at least one hyperparameter value HPV is information indicative of the value that has been set by the setting unit 13. The data DI for display is an example of presentation information that is presented by the presentation unit 14.

<Overview of Procedure>

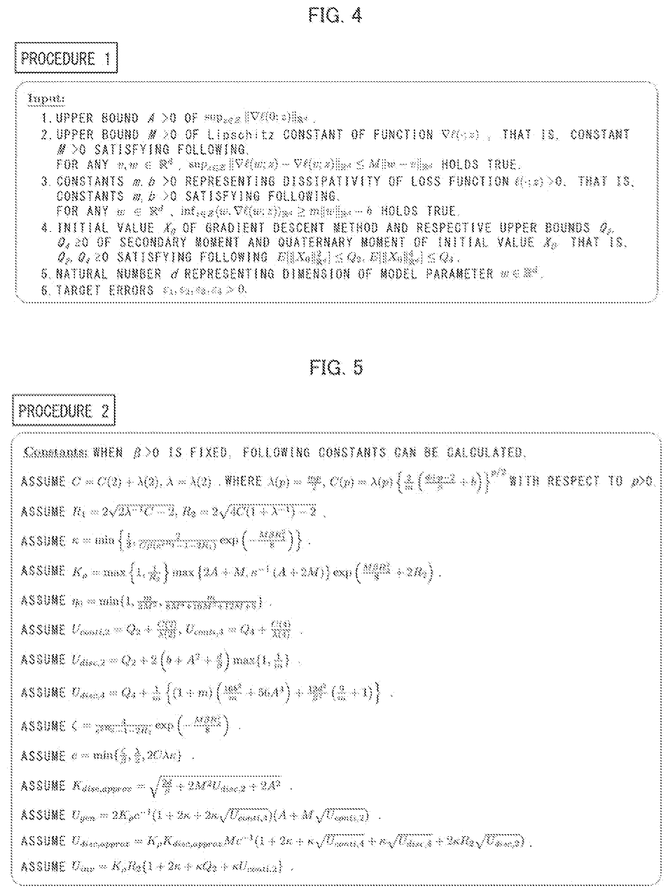

An example of a specific procedure for determining a range to be satisfied by a hyperparameter in accordance with the second example embodiment will be described with reference to FIGS. 4 to 6. In this example, the procedure for determining the range to be satisfied by the hyperparameter is roughly divided into procedures 1 to 3. The procedures 1 to 3, which are respective processes carried out by the information processing apparatus 1A, do not necessarily mean to limit procedures for the respective processes.

This example describes a procedure for determining a range to be satisfied by a hyperparameter for use in learning by a gradient descent method X_{kη}^{(n,η)}. The hyperparameter for use in learning by the gradient descent method X_{kη}^{(n,η)} includes, for example, the following:
a sample size n of training data
a learning rate η
the number k of parameter update times
an inverse temperature β

Note here that the sample size n∈N of the training data is a sample size of training data z∈Z for use in learning by the gradient descent method X_{kη}^{(n,η)}. The learning rate η is a learning rate of learning by the gradient descent method X_{kη}^{(n,η)}. The number k∈N of parameter update times is the number of times of update of a model parameter w∈R^{d} that is updated by the gradient descent method X_{kη}^{(n,η)}.

Assume in this example that l(w;z) is a loss function at the model parameter w∈R^{d} in the training data z∈Z, and an expected loss, which is an expected value of the loss function l(w;z), is expressed by the following equation:

L(w)= [symbol] [ [symbol] (w;z)]

Assume also that with respect to independent samples z₁, . . . , zₙ in accordance with D, an empirical loss is expressed by the following equation:

$${L}_{n} ( w ) = \frac{1}{n} {\sum }_{i = 1}^{n} ℓ ( w ; {z}_{i} )$$

Furthermore, assume that the gradient descent method X_{kη}^{(n,η)} which has the learning rate η>0 and the inverse temperature β>0 is defined as the following equation:

$${X}_{( k + 1 ) η}^{( n , η )} = {X}_{k η}^{( n , η )} - η ∇ {L}_{n} ( {X}_{k η}^{( n , η )} ) + \sqrt{\frac{2 η}{β}} {N}_{k}$$

where Nₖ is an independent column of a d-dimensional standard normal distribution, the independent column being independent of z₁, . . . zₙ.

(Procedure 1)

FIG. 4 is a diagram for describing the procedure 1. In the procedure 1, the input information IMF is input to the information processing apparatus 1A. In FIG. 4, the input information IMF includes the following:
(i) a constant A representing an upper bound of a norm at an origin of a gradient of the loss function l(w;z);
(ii) a constant M representing a Lipschitz constant of the gradient of the loss function l(w;z);
(iii) constants m and b representing dissipativity of the loss function l(w;z);
(iv) a constant Q₂ representing an upper bound of a secondary moment of an initial distribution;
(v) a constant Q₄ representing an upper bound of a quaternary moment of the initial distribution;
(vi) target errors ε₁, ε₂, ε₃, and ε₄; and
(vii) a dimension d of the model parameter w∈R^{d}.
   Conditions for information of the above (i) to (vii) are as shown in FIG. 4.

An example of a method for setting the information of the above (i) to (vii) is described here. This example uses a regression problem caused by a single-layer neural network to provide a description so as to facilitate understanding of the description. Note, however, that same applies to handling of the setting in a case where the number of layers of a neural network is increased. A set of a d-dimensional input variable x=(x₁, . . . x_{d}) and a one-dimensional output variable y is expressed by z=(x,y). Furthermore, a d-dimensional model parameter w is expressed by w=(w₁, . . . w_{d}). An activation function is expressed by σ:R→R. (that is, σ is a map in which a real value is mapped to a real value). In this case, with respect to a normalization parameter λ>0, assume the following equation:

[symbol]

(w;z)=|y−σ(Σᵢ₌₁^{d}wᵢxᵢ)|²+λ∥w

[symbol]

where

∥w [symbol] =\sqrt{w₁²+ . . . +w_{d}²}

where first- and second-order differentials of σ are represented by σ′ and σ″, respectively, and upper limits of respective absolute values of σ, σ′, and σ″ are represented by ∥σ∥₂₈, ∥σ′∥_{∞}, and ∥σ″∥₂₈, respectively.

(Setting of Constant A>0)

By definition of the loss function l(w;z), a gradient thereof is given by the following equation:

∇ [symbol] (w;z)=2(y−σ(Σᵢ₌₁^{d}wᵢxᵢ))σ′(Σᵢ₌₁^{d}wᵢxᵢ)x+2λw (Expression 1)

where σ′ is a differential of σ. This results in the following equation:

∇ [symbol] (0;z)=2(y−σ(0))σ′(0)x

Thus, the constant A>0 may be set as an upper bound of the following in a case where a data point z=(x,y) is moved.

2(|y|+∥σ∥∞)∥σ′∥∞∥x

[symbol]

(Setting of Constant M>0)

The above (Expression 1) causes the following to hold true.

$$\text{?}$$

$$\text{?} \text{indicates text missing or illegible when filed}$$

Thus, the constant M>0 may be set as an upper bound of the following in a case where the data point z=(x,y) is moved.

2{λ+(|y|+∥σ∥∞)∥σ″∥∞∥x [symbol] +∥σ′∥∞∥x [symbol] }

(Setting of Constants m and b>0)

The constant A>0 is set as the upper bound of the following in a case where the data point z=(x,y) is moved.

2(|y|+∥σ∥∞)∥σ′∥∞∥x

[symbol]

Thus, the above (Expression 1) causes the following to hold true.

$$\begin{matrix}{〈 w , ∇ ℓ ( w ; 𝓏 ) 〉}_{{ℝ}^{d}} = 2 λ {‖ w ‖}_{{ℝ}^{d}}^{2} + 2 ( y - σ ( {\sum }_{i = 1}^{d} {w}_{i} {x}_{i} ) ) {σ}^{′} ( {\sum }_{i = 1}^{d} {w}_{i} {x}_{i} ) {〈 w , x 〉}_{{ℝ}^{d}} \\ \geq 2 λ {‖ w ‖}_{{ℝ}^{d}}^{2} - 2 ( \vert y \vert + {‖ σ ‖}_{∞} ) {‖ {σ}^{′} ‖}_{∞} {‖ x ‖}_{{ℝ}^{d}} {‖ w ‖}_{{ℝ}^{d}} \\ \geq 2 λ {‖ w ‖}_{{ℝ}^{d}}^{2} - A {‖ w ‖}_{{ℝ}^{d}} \\ \geq 2 λ {‖ w ‖}_{{ℝ}^{d}}^{2} - ( \frac{{A}^{2}}{4 λ} + λ {‖ w ‖}_{{ℝ}^{d}}^{2} ) \\ \geq λ {‖ w ‖}_{{ℝ}^{d}}^{2} - \frac{{A}^{2}}{4 λ}\end{matrix}$$

This makes it possible to set m=λ and the following:

$$b = \frac{{A}^{2}}{4 λ}$$

(Setting of Constants Q₂ and Q₄)

For example, by setting the initial value as the origin, it is possible to set Q₂=Q₄=0.

(Setting of Dimension d)

The dimension d may be determined as a dimension of the input variable x=(x₁, . . . x_{d}).

(Setting of Target Errors ε₁, ε₂, ε₃, ε_{4>0})

The target errors ε₁, ε₂, ε₃, and ε₄ may be arbitrarily set by the user.

(Procedure 2)

FIG. 5 is a diagram for describing the procedure 2. In the procedure 2, in a case where the inverse temperature β is determined, the input information IMF and the inverse temperature β can be used to calculate constants C, R₁, κ, K_{ρ}, η₀, U_{conti, 2}, U_{disc, 4}, ζ, c, K_{disc, approx}, U_{gen}, U_{disc, approx}, and Uᵢₙᵥ that are shown in FIG. 5. FIG. 5 shows an example of formulas by which the respective constants are calculated.

The determination unit 12 carries out calculation related to parameters and shown in the procedure 2. Note, however, that calculation related to some of these parameters may be configured to be carried out in advance by a human being.

(Procedure 3)

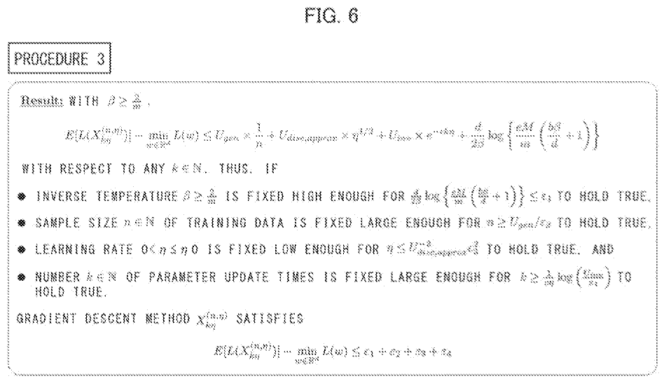

FIG. 6 is a diagram for describing the procedure 3. With the inverse temperature β≥2/m, the following holds true with respect to any k∈N.

$$\text{?}$$

$$\text{?} \text{indicates text missing or illegible when filed}$$

Thus, in a case where the range of the hyperparameter is determined as a range satisfying the condition shown in FIG. 6, the gradient descent method X_{kη}^{(n,η)} satisfies the following:

$$E [ L ( {X}_{k η}^{( n , η )} ) ] - {min}_{w ∈ {ℝ}^{d}} L ( w ) \leq {ε}_{1} + {ε}_{2} + {ε}_{3} + {ε}_{4}$$

In this case, the determination unit 12 determines the following ranges:

a range of the inverse temperature β satisfying the following inequality:

$$\frac{d}{2 β} log \{ \frac{eM}{m} ( \frac{b β}{d} + 1 ) \} \leq {ε}_{1} ;$$

a range of the sample size n satisfying the following inequality:

n≥U_{gen}/ε₂ (Expression 2);

a range of the learning rate η satisfying the following inequality:

η≥U_{disc,approx}⁻²ε₃² (Expression 3); and

a range of the number k of parameter update times, k satisfying the following inequality:

$$k \geq \frac{1}{c η} log ( \frac{{U}_{inv}}{{ε}_{4}} ) \qquad ( Expression 4 )$$

(Flow of Information Processing Method)

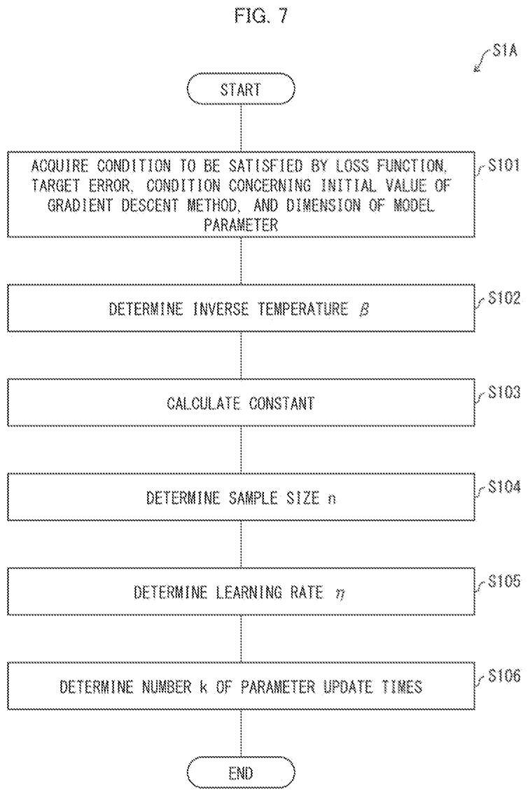

FIG. 7 is a flowchart showing a flow of an information processing method S1A that is an example of the information processing method carried out by the information processing apparatus 1A.

(Step S101)

In a step S101, the acquisition unit 11 acquires a condition to be satisfied by the loss function l(w;z), a target error, a condition concerning an initial value of the gradient descent method X_{kη}^{(n,η)}, and a dimension of a model parameter. More specifically, the acquisition unit 11 acquires the input information IMF including (i) the constant A, (ii) the constant M, (iii) the constants m and b, (iv) the constant Q₂, (v) the constant Q₄, (vi) the target errors ε₁, ε₂, ε₃, and ε₄, and (vii) the dimension d of the model parameter.

The acquisition unit 11 may receive the input information IMF from another apparatus via the communication unit 40A or acquire the input information IMF that is input to the input/output unit 30A. The acquisition unit 11 may read the input information IMF from the storage unit 20A or another external storage apparatus so as to acquire the input information IMF.

(Step S102)

In a step S102, the determination unit 12 determines the inverse temperature β. The inverse temperature β is determined by, for example, the method disclosed in Non-patent Literature 1. Note, however, that the inverse temperature β may be determined not only by the example described earlier but also by another method.

(Step S103)

In a step S103, the determination unit 12 calculates a constant for use in determination of the range of the hyperparameter. For example, the determination unit 12 uses the information of the above (i) to (vii) included in the input information IMF to calculate the constants C, R₁, κ, K_{ρ}, η₀, U_{conti, 2}, U_{disc, 4}, ζ, c, K_{disc, approx}, U_{gen}, U_{disc, approx}, and Uᵢₙᵥ that are shown in the procedure 2 described earlier.

(Step S104)

In a step S104, the determination unit 12 and the setting unit 13 use the target error ε₂ and the information of the above (i) to (vii) included in the input information IMF to determine the sample size n of a training data set. More specifically, for example, the determination unit 12 determines, as a range to be satisfied by the sample size n, a range satisfying the above (Expression 2). The setting unit 13 sets a value of the sample size n so that the value falls within the range which has been determined by the determination unit 12.

(Step S105)

In a step S105, the determination unit 12 and the setting unit 13 use the target error ε₃ and the information of the above (i) to (vii) included in the input information IMF to determine the learning rate η. More specifically, for example, the determination unit 12 determines, as a range to be satisfied by the learning rate η (0<η≤η₀), a range satisfying the above (Expression 3). The setting unit 13 sets a value of the learning rate η so that the value falls within the range which has been determined by the determination unit 12.

(Step S106)

In a step S106, the determination unit 12 and the setting unit 13 use the target error ε₄ and the information of the above (i) to (vii) included in the input information IMF to determine the number k of parameter update times. More specifically, for example, the determination unit 12 determines, as a range to be satisfied by the number k of parameter update times, a range satisfying the above (Expression 4). The setting unit 13 sets the number k of parameter update times so that the number k falls within the range which has been determined by the determination unit 12.

In the information processing method S1A, the information processing apparatus 1A may carry out the step S105 and/or the step S106 before the step S104.

The presentation unit 14 outputs information indicative of at least one selected from the group consisting of the range to be satisfied by the hyperparameter, the range having been determined by the determination unit 12, and the value of the hyperparameter, the value having been set by the setting unit 13. For example, the presentation unit 14 may output the information to the display panel or the like of the input/output unit 30A or may transmit the information so as to output the information to another apparatus connected thereto via the communication unit 40A. The presentation unit 14 may write the information to the storage unit 20A or another external storage apparatus so as to output the information.

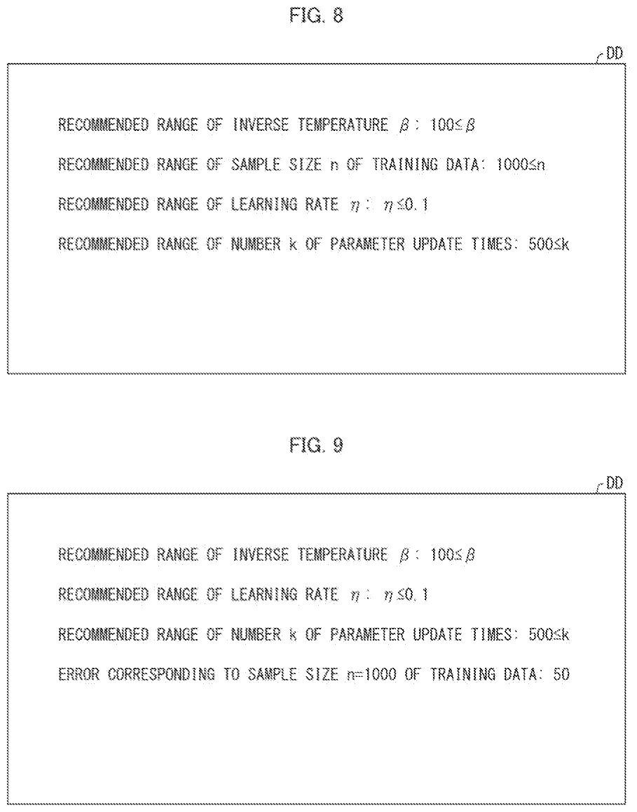

FIG. 8 is a diagram illustrating display data DD displayed on the display panel of the input/output unit 30A. In FIG. 8, the display data DD includes a recommended range of the inverse temperature β, a recommended range of the sample size n of the training data, a recommended range of the learning rate η, and a recommended range of the number k of parameter update times.

<Effect of Information Processing Apparatus>

As described above, the information processing apparatus 1A in accordance with the second example embodiment employs a configuration further including the setting unit 13 that sets a value of the at least one hyperparameter so that the value falls within the range which has been determined by the determination unit 12. Thus, the information processing apparatus 1A in accordance with the second example embodiment brings about not only the effect brought about by the information processing apparatus 1 in accordance with the first example embodiment but also an effect of making it possible to more appropriately determine a hyperparameter for use in learning by a gradient descent method. Furthermore, in a case where the presentation unit 14 presents the hyperparameter that has been set by the setting unit 13, for example, a user of the information processing apparatus 1A can understand in advance a value of the hyperparameter which value is effective for learning. In particular, the second example embodiment enables the user to understand in advance a size of a training data set which size is required for achievement of generalization performance within a target error.

The information processing apparatus 1A in accordance with the second example embodiment employs a configuration further including the presentation unit 14 that presents the range which has been determined by the determination unit 12. Thus, the information processing apparatus 1A in accordance with the second example embodiment brings about not only the effect brought about by the information processing apparatus 1 in accordance with the first example embodiment but also an effect of enabling the user to understand a suitable range of the hyperparameter for use in learning by the gradient descent method. In a case where the range of the hyperparameter is presented, the user can understand ground for setting of the parameters. Furthermore, the user can set the hyperparameter with reference to the presented range.

The information processing apparatus 1A in accordance with the second example embodiment employs a configuration such that the plurality of hyperparameters include at least one selected from the group consisting of a sample size of training data, a learning rate, and the number of parameter update times. Thus, the information processing apparatus 1A in accordance with the second example embodiment brings about not only the effect brought about by the information processing apparatus 1 in accordance with the first example embodiment but also an effect of making it possible to more appropriately determine a range of at least one selected from the group consisting of a sample size of training data, a learning rate, and the number of parameter update times, the sample size, the learning rate, and the number each being the hyperparameter for use in learning by the gradient descent method.

The information processing apparatus 1A in accordance with the second example embodiment employs a configuration such that the plurality of hyperparameters include an inverse temperature. Thus, the information processing apparatus 1A in accordance with the second example embodiment brings about not only the effect brought about by the information processing apparatus 1 in accordance with the first example embodiment but also an effect of making it possible to more appropriately determine a range of the inverse temperature, the inverse temperature being the hyperparameter for use in learning by the gradient descent method.

The information processing apparatus 1A in accordance with the second example embodiment employs a configuration such that the condition to be satisfied by the loss function includes at least one selected from the group consisting of a constant representing an upper bound of a norm at an origin of a gradient of the loss function, a constant representing a Lipschitz constant of the gradient of the loss function, and a constant representing dissipativity of the loss function. Thus, the information processing apparatus 1A in accordance with the second example embodiment brings about an effect of making it possible to more appropriately determine the hyperparameter for use in learning by the gradient descent method.

The information processing apparatus 1A in accordance with the second example embodiment employs a configuration such that the condition concerning the initial value of the gradient descent method includes at least one selected from the group consisting of a constant representing an upper bound of a secondary moment of an initial distribution and a constant representing an upper bound of a quaternary moment of the initial distribution. Thus, the information processing apparatus 1A in accordance with the second example embodiment brings about an effect of making it possible to more appropriately determine the hyperparameter for use in learning by the gradient descent method.

<Variation>

(First Variation)

In the foregoing second example embodiment, in a case where it is impossible to increase the sample size n of the training data z, the information processing apparatus 1A may determine a range of another hyperparameter without carrying out a process for determining the range of the sample size n. In this case, the information processing apparatus 1A receives a user input related to the sample size n and fixes the input sample size n. In this case, a condition under which the expected loss is minimized within a target error is expressed as below. Thus, the expected loss is minimized within the target error so that the condition is satisfied.

$$E [ L ( {X}_{k η}^{( n , η )} ) ] - {min}_{w ∈ {ℝ}^{d}} L ( w ) \leq {ε}_{1} + {U}_{gen} {n}^{- 1} + {ε}_{3} + {ε}_{4}$$

The presentation unit 14 incorporates, in the display data DD, a specific value for an error (U_{gen}ⁿ⁻¹) corresponding to an input specific value of the sample size. FIG. 9 is a diagram illustrating the display data DD displayed on the display panel of the input/output unit 30A. In FIG. 9, the display data DD includes the recommended range of the inverse temperature β, the recommended range of the number k of parameter update times, and an error corresponding to the sample size n of the training data.

According to this example aspect, by understanding a limit of generalization performance provided by a used data set, it is possible to determine validity of a result of test data for a model constructed by the gradient descent method X_{kη}^{(n,η).}

(Second Variation)

In the foregoing second example embodiment, the information processing apparatus 1A may include a learning unit (not illustrated) that uses the determined hyperparameter to carry out learning by the gradient descent method.

### Software Implementation Example

Some or all of functions of the information processing apparatus 1 or 1A can be realized by hardware provided in an integrated circuit (IC chip) or the like or can be alternatively realized by software.

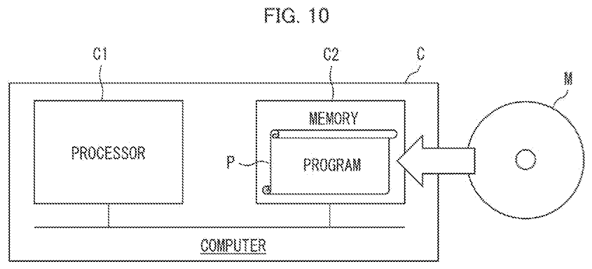

In the latter case, the information processing apparatus 1 or 1A is realized by, for example, a computer that executes instructions of a program that is software realizing the foregoing functions. FIG. 10 illustrates an example of such a computer (hereinafter referred to as a “computer C”). The computer C includes at least one processor C1 and at least one memory C2. The at least one memory C2 stores a program P for causing the computer C to operate as the information processing apparatus 1 or 1A. In the computer C, the at least one processor C1 reads and executes the program P stored in the at least one memory C2, so that the functions of the information processing apparatus 1 or 1A are realized.

Examples of the at least one processor C1 encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the at least one memory C2 encompass a flash memory, a hard disk drive (HDD), a solid state drive (SSD), and a combination thereof.

Note that the computer C may further include a random access memory (RAM) in which the program P is to be loaded while being executed and in which various kinds of data are to be temporarily stored. The computer C may further include a communication interface through which data is to be transmitted and received between the computer C and at least one other apparatus. The computer C may further include an input/output interface through which an input/output device(s) such as a keyboard, a mouse, a display and/or a printer is/are to be connected to the computer C.

The program P can be recorded in a non-transitory, tangible storage medium M capable of being read by the computer C. Examples of such a storage medium M encompass a tape, a disk, a card, a semiconductor memory, and a programmable logic circuit. The computer C can acquire the program P via the storage medium M. The program P can alternatively be transmitted via a transmission medium. Examples of such a transmission medium encompass a communication network and a broadcast wave. The computer C can alternatively acquire the program P via the transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can be described as, but not limited to, the following supplementary notes.

(Supplementary Note 1)

An information processing apparatus including: an acquisition means that acquires at least one selected from the group consisting of a condition to be satisfied by a loss function, a target error, a condition concerning an initial value of a gradient descent method, and a dimension of a model parameter; and a determination means that determines a range to be satisfied by at least one hyperparameter selected from the group consisting of a plurality of hyperparameters for use in learning by the gradient descent method, the range being determined in accordance with information which has been acquired by the acquisition unit.

(Supplementary Note 2)

An information processing apparatus according to Supplementary note 1, further including a setting means that sets a value of the at least one hyperparameter so that the value falls within the range which has been determined in the determination means.

(Supplementary Note 3)

An information processing apparatus according to Supplementary note 1, further including a presentation means that presents the range which has been determined by the determination means.

(Supplementary Note 4)

The information processing apparatus according to any one of Supplementary notes 1 to 3, wherein the plurality of hyperparameters include at least one selected from the group consisting of the following: a sample size of training data; a learning rate; and the number of parameter update times.

(Supplementary Note 5)

The information processing apparatus according to Supplementary note 4, wherein the plurality of hyperparameters include an inverse temperature.

(Supplementary Note 6)

The information processing apparatus according to any one of Supplementary notes 1 to 5, wherein the condition to be satisfied by the loss function includes at least one selected from the group consisting of the following: a constant representing an upper bound of a norm at an origin of a gradient of the loss function; a constant representing a Lipschitz constant of the gradient of the loss function; and a constant representing dissipativity of the loss function.

(Supplementary Note 7)

The information processing apparatus according to any one of Supplementary notes 1 to 6, wherein the condition concerning the initial value of the gradient descent method includes at least one selected from the group consisting of the following: a constant representing an upper bound of a secondary moment of an initial distribution; and a constant representing an upper bound of a quaternary moment of the initial distribution.

(Supplementary Note 8)

An information processing method including:
(a) acquiring at least one selected from the group consisting of a condition to be satisfied by a loss function, a target error, a condition concerning an initial value of a gradient descent method, and a dimension of a model parameter; and
(b) determining a range to be satisfied by at least one hyperparameter selected from the group consisting of a plurality of hyperparameters for use in learning by the gradient descent method, the range being determined in accordance with information which has been acquired in the above (a),

the above (a) and (b) being carried out by at least one processor.

(Supplementary Note 9)

An information processing program for causing a computer to function as: an acquisition means that acquires at least one selected from the group consisting of a condition to be satisfied by a loss function, a target error, a condition concerning an initial value of a gradient descent method, and a dimension of a model parameter; and a determination means that determines a range to be satisfied by at least one hyperparameter selected from the group consisting of a plurality of hyperparameters for use in learning by the gradient descent method, the range being determined in accordance with information which has been acquired by the acquisition means.

(Supplementary Note 10)

An information processing apparatus including at least one processor, the at least one processor carrying out: an acquisition process for acquiring at least one selected from the group consisting of a condition to be satisfied by a loss function, a target error, a condition concerning an initial value of a gradient descent method, and a dimension of a model parameter; and a determination process for determining a range to be satisfied by at least one hyperparameter selected from the group consisting of a plurality of hyperparameters for use in learning by the gradient descent method, the range being determined in accordance with information which has been acquired in the acquisition process.

Note that the information processing apparatus may further include a memory, which may store a program for causing the at least one processor to carry out the acquisition process and the determination process. Furthermore, the program may be recorded in a non-transitory, tangible computer-readable storage medium.

### REFERENCE SIGNS LIST

1, 1A Information processing apparatus
11 Acquisition unit
12 Determination unit
13 Setting unit
14 Presentation unit
S1, S1A Information processing method

1. An information processing apparatus comprising at least one processor, the at least one processor carrying out:
an acquisition process for acquiring at least one selected from the group consisting of a condition to be satisfied by a loss function, a target error, a condition concerning an initial value of a gradient descent method, and a dimension of a model parameter; and
a determination process for determining a range to be satisfied by at least one hyperparameter selected from the group consisting of a plurality of hyperparameters for use in learning by the gradient descent method, the range being determined in accordance with information which has been acquired in the acquisition process.

2. The information processing apparatus according to claim 1, wherein the at least one processor further carries out a setting process for setting a value of the at least one hyperparameter so that the value falls within the range which has been determined in the determination process.

3. The information processing apparatus according to claim 1, wherein the at least one processor further carries out a presentation process for presenting the range which has been determined in the determination process.

4. The information processing apparatus according to claim 1, wherein the plurality of hyperparameters include at least one selected from the group consisting of the following:
a sample size of training data;
a learning rate; and
the number of parameter update times.

5. The information processing apparatus according to claim 4, wherein the plurality of hyperparameters include an inverse temperature.

6. The information processing apparatus according to claim 1, wherein the condition to be satisfied by the loss function includes at least one selected from the group consisting of the following:
a constant representing an upper bound of a norm at an origin of a gradient of the loss function;
a constant representing a Lipschitz constant of the gradient of the loss function; and
a constant representing dissipativity of the loss function.

7. The information processing apparatus according to claim 1, wherein the condition concerning the initial value of the gradient descent method includes at least one selected from the group consisting of the following:
a constant representing an upper bound of a secondary moment of an initial distribution; and
a constant representing an upper bound of a quaternary moment of the initial distribution.

8. An information processing method comprising:
(a) acquiring at least one selected from the group consisting of a condition to be satisfied by a loss function, a target error, a condition concerning an initial value of a gradient descent method, and a dimension of a model parameter; and
(b) determining a range to be satisfied by at least one hyperparameter selected from the group consisting of a plurality of hyperparameters for use in learning by the gradient descent method, the range being determined in accordance with information which has been acquired in the above (a),
the above (a) and (b) being carried out by at least one processor.

9. A non-transitory storage medium storing an information processing program for causing a computer to carry out:
an acquisition process for acquiring at least one selected from the group consisting of a condition to be satisfied by a loss function, a target error, a condition concerning an initial value of a gradient descent method, and a dimension of a model parameter; and
a determination process for determining a range to be satisfied by at least one hyperparameter selected from the group consisting of a plurality of hyperparameters for use in learning by the gradient descent method, the range being determined in accordance with information which has been acquired in the acquisition process.
